(19) United States
(12) Patent Application Publication
(10) Pub. No.: US 2021/0178546 A1
(43) Pub. Date: Jun. 17, 2021

(54) MACHINE TOOL AND VIBRATION ESTIMATION METHOD

(71) Applicant: FANUC CORPORATION, Yamanashi (JP)

(72) Inventor: Masahiro MUROTA, Yamanashi-ken (JP)

(21) Appl. No.: 17/123,524

(22) Filed: Dec. 16, 2020

(30) Foreign Application Priority Data
Dec. 17, 2019 (JP) 2019-227061
Mar. 19, 2020 (JP) 2020-048618

(51) Int. Cl. B23Q 17/12

(52) U.S. Cl. CPC B23Q 17/12; B23Q 2717/003; B23Q 2220/006

(57) ABSTRACT

A machine tool includes: a spindle unit for rotatably supporting a spindle; a moving mechanism for moving the spindle unit; a motor for driving the moving mechanism; a motor control unit for controlling the motor; and an estimation unit for estimating that abnormal vibration is likely to have occurred in the spindle when the amplitude of a signal indicating the driving state of the motor falls out of a predetermined allowable range.

### CROSS-REFERENCE TO RELATED APPLICATION

This application is based upon and claims the benefit of priority from Japanese Patent Applications No. 2019-227061 filed on Dec. 17, 2019 and No. 2020-048618 filed on Mar. 19, 2020, the contents all of which are incorporated herein by reference.

### BACKGROUND OF THE INVENTION

### Field of the Invention

The present invention relates to a machine tool for estimating abnormal vibration of a spindle as well as relating to a vibration estimation method.

### Description of the Related Art

Japanese Laid-Open Patent Publication No. 2008-132558 discloses an abnormality detection method in which data on vibration arising during machining is acquired from a vibration sensor attached to a tool so as to detect abnormal vibration based on the acquired vibration data.

### SUMMARY OF THE INVENTION

However, in the above abnormality detection method, it is necessary to attach a vibration sensor for acquiring vibration data concerning the tool, and the number of parts of the machine tool accordingly increases.

It is therefore an object of the present invention to provide a machine tool and a vibration estimation method capable of reducing the number of parts.

The first aspect of the present invention resides in a machine tool, including: a spindle unit configured to rotatably support a spindle; a moving mechanism configured to move the spindle unit; a motor configured to drive the moving mechanism; a motor control unit configured to control the motor; and an estimation unit configured to estimate that abnormal vibration is likely to have occurred in the spindle when an amplitude of a signal indicating a driving state of the motor falls out of a predetermined allowable range.

The second aspect of the present invention resides in a vibration estimation method for estimating abnormal vibration of a spindle of a machine tool, the machine tool including a spindle unit configured to rotatably support the spindle, a moving mechanism configured to move the spindle unit, a motor configured to drive the moving mechanism, and a motor control unit configured to control the motor, the vibration estimation method including: an acquisition step of acquiring a signal indicating a driving state of the motor; and an estimation step of estimating that abnormal vibration is likely to have occurred in the spindle when an amplitude of the signal acquired at the acquisition step falls out of a predetermined allowable range.

The third aspect of the present invention resides in a machine tool, including: a spindle unit configured to rotatably support a spindle; a moving mechanism configured to move the spindle unit; a motor configured to drive the moving mechanism; a motor control unit configured to control the motor; and an estimation unit configured to estimate that abnormal vibration is likely to have occurred in the spindle when an intensity of a frequency component, contained in a signal indicating a driving state of the motor, that has the same frequency as a rotation frequency of the spindle, exceeds a predetermined threshold.

The fourth aspect of the present invention resides in a vibration estimation method for estimating abnormal vibration of a spindle of a machine tool, the machine tool including a spindle unit configured to rotatably support the spindle, a moving mechanism configured to move the spindle unit, a motor configured to drive the moving mechanism, and a motor control unit configured to control the motor, the vibration estimation method including: an acquisition step of acquiring a signal indicating a driving state of the motor; and an estimation step of estimating that abnormal vibration is likely to have occurred in the spindle when an intensity of a frequency component, contained in the signal acquired at the acquisition step, that has the same frequency as a rotation frequency of the spindle, exceeds a predetermined threshold.

According to the aspects of the present invention, it is possible to detect abnormal vibration without providing any vibration sensor, and hence reduce the number of parts.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a machine tool of the present embodiment;

FIG. 2 is a graph showing a signal waveform of the positional deviation of a motor;

FIG. 3 is a graph showing a signal waveform of the positional deviation of the motor, including a period with no abnormal vibration occurring and a period with abnormal vibration occurring, with a set allowable range being superposed;

FIG. 4 is a flowchart showing a flow of vibration estimation process;

FIG. 5 is a diagram showing how the allowable range is expanded in periods of acceleration and deceleration of a moving mechanism during machining;

FIG. 6 is a graph showing a signal waveform of the positional deviation of the motor, including a period with an abnormal vibration occurring, together with a set allowable range, a first expanded range, and a second expanded range; and

FIG. 7 is a graph showing a signal waveform obtained by transforming the signal of the positional deviation of a motor (time domain signal) into a frequency domain signal, together with a set threshold TH.

### DESCRIPTION OF THE PREFERRED EMBODIMENTS

A preferred embodiment of the present invention will be described below, in detail, with reference to the accompanying drawings.

### Embodiment

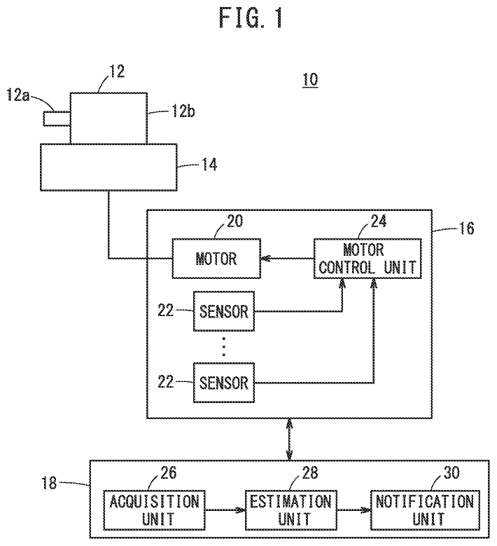

FIG. 1 is a schematic diagram showing a machine tool 10 of the present embodiment. The machine tool 10 machines a workpiece with a tool. Specific examples of the machine tool 10 include a lathe machine and a machining center. The machine tool 10 includes a spindle unit 12, a moving mechanism 14, a control device 16, and a vibration estimation device 18.

The spindle unit 12 is a structural portion that rotatably supports a spindle 12a, and includes the spindle 12a and a housing 12b having a bearing attached thereto for supporting the spindle 12a. A spindle motor or the like for rotationally driving the spindle 12a is attached to the housing 12b. The spindle unit 12 is a portion corresponding to a headstock (spindle stock) when the machine tool 10 is a lathe machine, and is a portion corresponding to a spindle head when the machine tool 10 is a machining center. The spindle unit 12 is mounted on the moving mechanism 14.

The moving mechanism 14 is a mechanism for moving the spindle unit 12. The moving mechanism 14 may be a linear movement mechanism having an axis, or may be a linear movement mechanism having no axis. The moving mechanism 14 moves the spindle unit 12 in a first direction in which the spindle 12a extends, a second direction orthogonal to the first direction in a plane, or a third direction orthogonal to each of the first direction and the second direction. The control device 16 may define a machine coordinate system in which the first direction is the Y-axis direction, the second direction is the X-axis direction, and the third direction is the Z-axis direction.

The control device 16, based on a machining program and machining conditions, controls the machine body including the spindle 12a and the moving mechanism 14. The machining program and machining conditions are stored in an unillustrated storage unit of the control device 16. The machining program defines the positions of a tool and a workpiece at a time of machining the workpiece. The machining conditions are conditions for machining the workpiece, and specifically include the moving speed of the moving mechanism 14. The control device 16 includes a motor 20 that drives the moving mechanism 14, a plurality of sensors 22 that detect physical quantities related to the motor 20, and a motor control unit 24 that controls the motor 20.

The motor control unit 24 gives a command to the motor 20 so that the physical quantity fed back from each of the multiple sensors 22 becomes a target value. When the motor 20 drives the moving mechanism 14 in accordance with the command, the moving mechanism 14 and the spindle unit 12 mounted on the moving mechanism 14 move in the first direction, the second direction, or the third direction.

The vibration estimation device 18 is provided outside the control device 16 and exchanges various information with the control device 16. The vibration estimation device 18 may be provided inside the control device 16. The vibration estimation device 18 estimates abnormal vibration of the spindle 12a based on a signal indicating the driving state of the motor 20 during machining. The driving state of the motor 20 include at least one of the positional deviation, the speed deviation, the acceleration deviation, the jerk deviation, the electric current value, the speed, the acceleration, and the jerk, of the motor 20. In the present embodiment, the positional deviation of the motor 20 is adopted as an index of the driving state of the motor 20. The vibration estimation device 18 includes an acquisition unit 26, an estimation unit 28, and a notification unit 30.

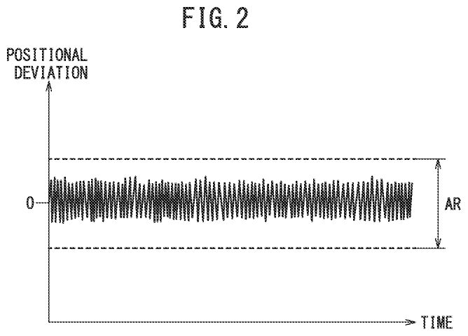

The acquisition unit 26 acquires a signal indicating the driving state of the motor 20 from the motor control unit 24. FIG. 2 is a graph showing a signal waveform of the positional deviation of the motor 20. The positional deviation of the motor 20 is obtained as a signal waveform whose amplitude varies periodically with the passage of time.

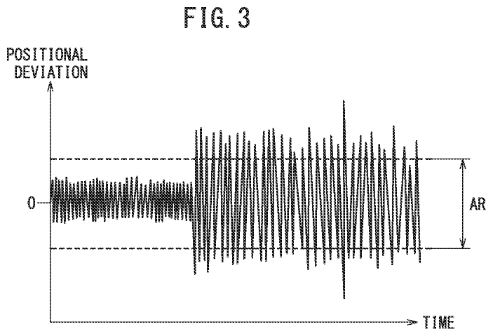

The estimation unit 28 monitors the varying amplitude of the signal indicating the driving state of the motor 20. FIG. 3 is a graph showing a signal waveform of the positional deviation of the motor 20 including a period with no abnormal vibration and a period with an abnormal vibration, together with a set allowable range AR. The amplitude of the positional deviation of the motor 20 has such a relationship that the amplitude becomes greater when an abnormal vibration is occurring than when no abnormal vibration is occurring. This relationship applies to the amplitude of the speed deviation, the acceleration deviation, the jerk deviation, the electric current value, the speed, the acceleration, or the jerk, of the motor 20, in the same manner as the amplitude of the positional deviation of the motor 20.

The estimation unit 28 compares the amplitude of the signal indicating the driving state of the motor 20 with the upper and lower limits of the predetermined allowable range AR. Here, when the amplitude of the signal indicating the driving state of the motor 20 is within the allowable range AR, the estimation unit 28 estimates that no abnormal vibration is occurring in the spindle 12a. The case where the amplitude is within the allowable range AR is a case where the amplitude is below the upper limit of the allowable range AR and above the lower limit of the allowable range AR.

On the other hand, when the amplitude of the signal indicating the driving state of the motor 20 falls out of the allowable range AR, the estimation unit 28 estimates that the spindle 12a is likely to be abnormally vibrating. The case where the amplitude falls out of the allowable range AR is a case where the amplitude is above the upper limit of the allowable range AR or below the lower limit of the allowable range AR. The estimation unit 28 may estimate that abnormal vibration may be occurring in the spindle 12a when a period during which the amplitude of the signal indicating the driving state of the motor 20 is out of the allowable range AR exceeds a predetermined time period. The period during which the amplitude is out of the allowable range AR is a period during which the positive peak and the negative peak of the periodically changing amplitude are continuously kept out of the allowable range AR.

When it is estimated that abnormal vibration is likely to have occurred in the spindle 12a, the notification unit 30 issues a notification of the estimation result. The notification unit 30 may issue a notification to the effect that the spindle 12a has been estimated to have a likelihood of abnormal vibration, by controlling at least one of a display unit, a speaker, and a light emitting unit. At least one of the display unit, the speaker, and the light emitting unit may be provided in the vibration estimation device 18, in the control device 16, or in an external device of the vibration estimation device 18, other than the control device 16.

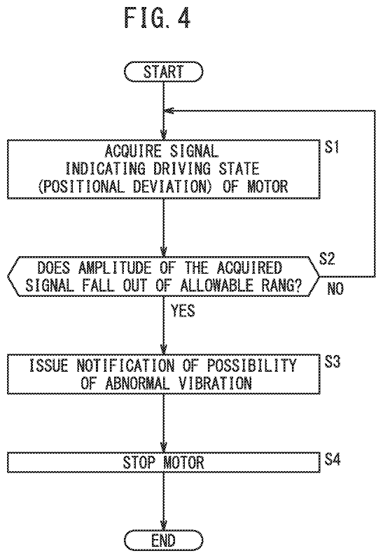

Next, as to the vibration estimation method of estimating abnormal vibration of the spindle 12a, a vibration estimation process of the vibration estimation device 18 will be described. FIG. 4 is a flowchart showing a flow of vibration estimation process.

At step S1, the acquisition unit 26 acquires a signal indicating the driving state of the motor 20 from the motor control unit 24. When the signal indicating the driving state of the motor 20 is acquired, the vibration estimation process proceeds to step S2.

At step S2, the estimation unit 28 compares the amplitude of the signal acquired at step S1 with the upper and lower limits of the predetermined allowable range AR. When the amplitude is within the allowable range AR, the estimation unit 28 estimates that no abnormal vibration is occurring in the spindle 12a. In this case, the vibration estimation process returns to step S1. On the other hand, when the amplitude falls out of the allowable range AR, the estimation unit 28 estimates that the spindle 12a is likely to be abnormally vibrating. In this case, the vibration estimation process proceeds to step S3.

At step S3, the notification unit 30 issues a notification to the effect that it has been estimated that abnormal vibration is likely to have occurred in the spindle 12a. When the notification that abnormal vibration is likely to have occurred is issued, the vibration estimation process proceeds to step S4.

At step S4, the motor control unit 24 stops the motor 20 that is driving the moving mechanism 14. When the motor 20 is stopped, the vibration estimation process ends.

### [Modification]

### (Modification 1)

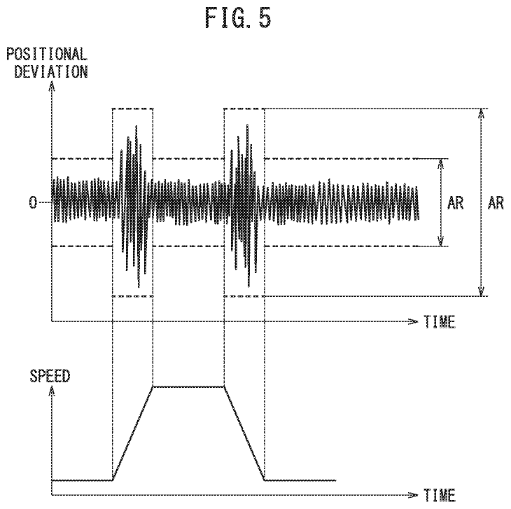

FIG. 5 is a diagram showing how the allowable range AR is expanded in the periods of acceleration and deceleration of the moving mechanism 14 during machining. In machining, there are two types of periods, i.e., a tool contact movement period during which the moving mechanism 14 moves with the tool being in contact with the workpiece, and a tool non-contact movement period during which the moving mechanism 14 moves with the workpiece and the tool being located away from each other. The motor control unit 24 controls the motor 20 so that the speed of the moving mechanism 14 during the tool non-contact movement period is higher than during the tool contact movement period. Therefore, when the moving mechanism 14 is accelerating or decelerating during machining, the amplitude of the signal indicating the driving state of the motor 20 tends to increase even though it is not an abnormal vibration.

Therefore, in this modification, the estimation unit 28 expands the allowable range AR when the moving mechanism 14 is accelerating or decelerating during machining. As a result, it is possible to suppress occurrence of an erroneous estimation that abnormal vibration may be occurring even though no abnormal vibration has actually occurred.

Note that the estimation unit 28 may recognize when the moving mechanism 14 is accelerating or decelerating during machining, based on a command output from the motor control unit 24 to the motor 20. Further, the estimation unit 28 may analyze the machining program and the machining conditions stored in the storage unit of the control device 16 to thereby recognize when the moving mechanism 14 is accelerating or decelerating during machining, based on the analysis result.

### (Modification 2)

The estimation unit 28 may suspend estimation when the moving mechanism 14 is accelerating or decelerating during machining. As a result, as in the case of Modification 1, it is possible to suppress occurrence of an erroneous estimation that abnormal vibration may be occurring even though no abnormal vibration has actually occurred.

### (Modification 3)

When it is estimated that abnormal vibration is likely to have occurred in the spindle 12a, the motor control unit 24 may stop the motor 20 at a higher deceleration rate as the degree to which the amplitude deviates from the allowable range AR is greater. In other words, the motor control unit 24 stops the motor 20 at a higher deceleration rate as the degree to which the amplitude falls out of the allowable range AR to deviate from the allowable range AR is greater. As a result, the higher the possibility of abnormal vibration, the more quickly the movement of the moving mechanism 14 is stopped, and thus it is possible to prevent the workpiece from being machined.

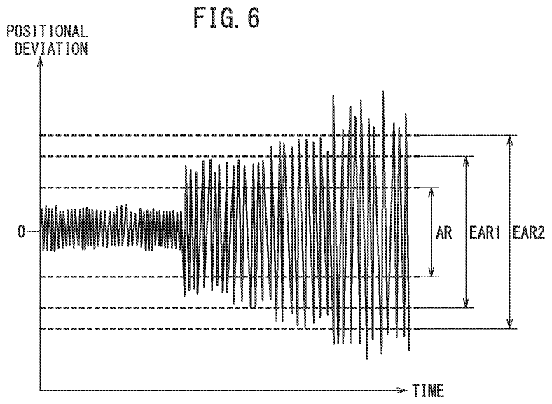

FIG. 6 is a graph showing a signal waveform of the positional deviation of the motor 20 including an occurrence of abnormal vibration, together with a set allowable range AR, a first expanded range EAR1, and a second expanded range EAR2. In Modification 3, for example, the first expanded range EAR1 larger than the allowable range AR and the second expanded range EAR2 larger than the first expanded range EAR1 are specified in advance. When the positive peak and the negative peak of the amplitude fall within the first expanded range EAR1, the motor control unit 24 sets a first deceleration rate (“low”) as the deceleration rate at which the motor 20 is stopped, and stops the motor 20 at the set first deceleration rate. When the positive peak and the negative peak of the amplitude fall out of the first expanded range EAR1 but within the second expanded range EAR2, the motor control unit 24 sets a second rate (“middle”) higher than the first deceleration rate, as the deceleration rate at which the motor 20 is stopped, and stops the motor 20 at the set second deceleration rate. When the positive peak and the negative peak of the amplitude fall out of the second expanded range EAR2, the motor control unit 24 sets a third deceleration rate (“high”) higher than the second deceleration rate, as the deceleration rate at which the motor 20 is stopped, and stops the motor 20 at the set third deceleration rate.

As shown in FIG. 6, the motor control unit 24 may increase the deceleration rate for stopping the motor 20, in a stepwise manner according to the degree to which the amplitude falls out of the allowable range AR to deviate from the allowable range AR. As a result, the higher the possibility of abnormal vibration becomes, the more quickly the movement of the moving mechanism 14 can be stopped, and thus it is possible to prevent the workpiece from being machined.

### (Modification 4)

The estimation unit 28 may monitor the intensity of a specific frequency component in the signal indicating the driving state of the motor 20 during machining. In this modification, the estimation unit 28 performs processing such as FFT (Fast Fourier Transform) on the signal indicating the driving state of the motor 20 during machining, and transforms the time domain signal into the frequency domain signal (frequency spectrum) that represents the contents of the frequency components.

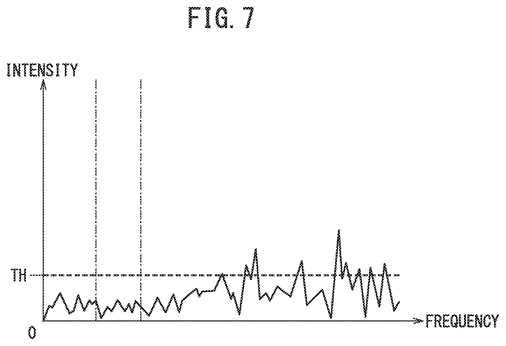

FIG. 7 is a graph showing a signal waveform (signal spectrum) obtained by transforming a signal of the positional deviation of the motor 20 (a time domain signal) into a frequency domain signal, together with a threshold TH. In the signal waveform in the frequency domain, the intensity (amplitude) at the time when an abnormal vibration is occurring tends to be greater than the intensity (amplitude) at the time when no abnormal vibration is occurring. This relationship also applies to cases where the signal of any of the speed deviation, the acceleration deviation, the jerk deviation, the electric current value, the speed, the acceleration, and the jerk, of the motor 20 is transformed into the signal in the frequency domain, in the same manner as the case where the positional deviation of the motor 20 is transformed into the signal in the frequency domain.

The estimation unit 28 compares the intensity of a frequency component, in the transformed frequency domain signal, that has the same frequency as the rotation frequency of the spindle 12a, with the predetermined threshold TH. When the intensity of the frequency component having the same frequency as the rotation frequency of the spindle 12a is equal to or lower than the threshold TH, the estimation unit 28 estimates that the spindle 12a is not subjected to abnormal vibration. Here, FIG. 7 shows a case where the intensity of the frequency component (the portion enclosed by the chain lines in the graph) having the same frequency as the rotation frequency of the spindle 12a does not exceed the threshold TH.

On the other hand, when the intensity of the frequency component having the same frequency as the rotation frequency of the spindle 12a is greater than the threshold TH (when it exceeds the threshold TH), the estimation unit 28 estimates that the spindle 12a is likely to have abnormal vibration. The estimation unit 28 may estimate that abnormal vibration is likely to be occurring in the spindle 12a when a period during which the intensity of the frequency component having the same frequency as the rotation frequency of the spindle 12a is more than the threshold TH exceeds a predetermined time period.

In the flow of the vibration estimation process of this modification, step S2 in FIG. 4 is partially changed. That is, at step S2, the estimation unit 28 transforms the signal (time domain signal) acquired at step S1 into the frequency domain signal, and compares, based on the transformed signal, the intensity of the frequency component having the same frequency as the rotation frequency of the spindle 12a with the predetermined threshold TH. Here, when the intensity is equal to or less than the threshold TH, the estimation unit 28 estimates that no abnormal vibration is occurring in the spindle 12a. In this case, the vibration estimation process returns to step S1. On the other hand, when the intensity exceeds the threshold TH, the estimation unit 28 estimates that the spindle 12a is likely to have abnormal vibration. In this case, the vibration estimation process proceeds to step S3.

In this way, also in this modification, abnormal vibration can be detected without providing a vibration sensor, as in the above embodiment. Further, in this modification, the presence or absence of abnormal vibration can be determined only for the vibration generated by the rotation of the spindle 12a.

It should be noted that this modification can be combined with any of the above modifications 1 to 3. That is, the estimation unit 28 may increase the threshold TH or suspend estimation when the moving mechanism 14 is accelerating or decelerating during machining. Further, when it is estimated that the spindle 12a is likely to be abnormally vibrating, the motor control unit 24 may stop the motor 20 at a higher deceleration rate as the degree to which the intensity exceeds the threshold TH to deviate from the threshold TH becomes greater. Moreover, when it is estimated that the spindle 12a is likely to be abnormally vibrating, the motor control unit 24 may increase the deceleration rate at which the motor 20 is stopped, in a stepwise manner according to the degree to which the intensity exceeds the threshold TH to deviate from the threshold TH.

### (Modification 5)

The above embodiment and modifications may be arbitrarily combined as long as no technical inconsistency occurs.

[Invention that can be Grasped from the Above]

The first to fourth aspects of the invention are described below as inventions that can be grasped from the above embodiment and modifications.

### <First Aspect of the Invention>

The first aspect of the invention resides in a machine tool (10). The machine tool (10) includes: a spindle unit (12) configured to rotatably support a spindle (12a); a moving mechanism (14) configured to move the spindle unit (12); a motor (20) configured to drive the moving mechanism (14); a motor control unit (24) configured to control the motor (20); and an estimation unit (28) configured to estimate that abnormal vibration is likely to have occurred in the spindle (12a) when the amplitude of a signal indicating the driving state of the motor (20) falls out of a predetermined allowable range (AR).

This configuration makes it possible to detect abnormal vibration without providing any vibration sensor, and hence reduce the number of parts of the machine tool (10).

The estimation unit (28) may be configured to expand the allowable range (AR) when the moving mechanism (14) is accelerating or decelerating during machining. This configuration makes it possible to suppress occurrence of an erroneous estimation that abnormal vibration is likely to be occurring even though no abnormal vibration has actually occurred.

The estimation unit (28) may be configured to suspend estimation when the moving mechanism (14) is accelerating or decelerating during machining. This makes it possible to suppress occurrence of an erroneous estimation that abnormal vibration is likely to be occurring even though no abnormal vibration has actually occurred.

The machine tool (10) may further include a notification unit (30) configured to, when it is estimated that abnormal vibration is likely to have occurred in the spindle (12a), issue a notification to the effect that it has been estimated that abnormal vibration is likely to have occurred in the spindle. This configuration makes it possible to prompt the operator to inspect the abnormal vibration.

The motor control unit (24) may be configured to stop the motor (20) when it is estimated that abnormal vibration is likely to have occurred in the spindle (12a). This configuration makes it possible to prevent the workpiece from being machined when it is estimated that abnormal vibration is likely to be occurring.

The motor control unit (24) may be configured to stop the motor (20) at a higher deceleration rate as the degree to which the amplitude falls out of the allowable rang (AR) to deviate from the allowable range (AR) is greater. With this configuration, the higher the possibility of occurrence of abnormal vibration becomes, the more quickly the movement of the moving mechanism (14) can be stopped, and it is possible to prevent the workpiece from being machined.

The motor control unit (24) may be configured to increase the deceleration rate at which the motor (20) is stopped, in a stepwise manner according to the degree to which the amplitude falls out of the allowable range (AR) to deviate from the allowable range (AR). With this configuration, the higher the possibility of occurrence of abnormal vibration becomes, the more quickly the movement of the moving mechanism (14) can be stopped, and it is possible to prevent the workpiece from being machined.

The driving state of the motor (20) may be represented by at least one of the positional deviation, the speed deviation, the acceleration deviation, the jerk deviation, the electric current value, the speed, the acceleration, and the jerk, of the motor (20).

### <Second Aspect of the Invention>

The second aspect of the invention resides in a vibration estimation method for estimating abnormal vibration of a spindle (12a) of a machine tool (10), the machine tool including a spindle unit (12) configured to rotatably support the spindle (12a), a moving mechanism (14) configured to move the spindle unit (12), a motor (20) configured to drive the moving mechanism (14), and a motor control unit (24) configured to control the motor (20). The vibration estimation method includes: an acquisition step (S1) of acquiring a signal indicating the driving state of the motor (20); and an estimation step (S2) of estimating that abnormal vibration is likely to have occurred in the spindle (12a) when the amplitude of the signal acquired at the acquisition step (S1) falls out of a predetermined allowable range (AR).

This method makes it possible to detect abnormal vibration without providing any vibration sensor, and hence reduce the number of parts of the machine tool (10).

The estimation step (S2) expands the allowable range (AR) when the moving mechanism (14) is accelerating or decelerating during machining. This method makes it possible to suppress occurrence of an erroneous estimation that abnormal vibration is likely to be occurring even though no abnormal vibration has actually occurred.

The estimation step (S2) may suspend estimation when the moving mechanism (14) is accelerating or decelerating during machining. This method makes it possible to suppress occurrence of an erroneous estimation that abnormal vibration is likely to be occurring even though no abnormal vibration has actually occurred.

The vibration estimation method may further include a notifying step (S3) of, when it is estimated that abnormal vibration is likely to have occurred in the spindle (12a), issuing a notification to the effect that abnormal vibration is likely to have occurred in the spindle (12a). This method makes it to prompt the operator to inspect the abnormal vibration.

The vibration estimation method may further include a stopping step (S4) of stopping the motor (20) when it is estimated that abnormal vibration is likely to have occurred in the spindle (12a). This method makes it possible to prevent the workpiece from being machined when it is estimated that abnormal vibration is likely to be occurring.

The stopping step (S4) may stop the motor (20) at a higher deceleration rate as the degree to which the amplitude falls out of the allowable range (AR) to deviate from the allowable range (AR) is greater. With this method, the higher the possibility of occurrence of abnormal vibration becomes, the more quickly the movement of the moving mechanism (14) can be stopped, and it is possible to prevent the workpiece from being machined.

The stopping step (S4) may increase the deceleration rate at which the motor (20) is stopped, in a stepwise manner according to the degree to which the amplitude falls out of the allowable range (AR) to deviate from the allowable range (AR). With this method, the higher the possibility of occurrence of abnormal vibration becomes, the more quickly the movement of the moving mechanism (14) can be stopped, and it is possible to prevent the workpiece from being machined.

### <Third Aspect of the Invention>

The third aspect of the invention resides in a machine tool (10). The machine tool (10) includes: a spindle unit (12) configured to rotatably support a spindle (12a); a moving mechanism (14) configured to move the spindle unit (12); a motor (20) configured to drive the moving mechanism (14); a motor control unit (24) configured to control the motor (20); and an estimation unit (28) configured to estimate that abnormal vibration is likely to have occurred in the spindle (12a) when the intensity of the frequency component, contained in a signal indicating the driving state of the motor (20), that has the same frequency as the rotation frequency of the spindle (12a), exceeds a predetermined threshold (TH).

This configuration makes it possible to detect abnormal vibration without providing any vibration sensor, and hence reduce the number of parts of the machine tool (10).

The estimation unit (28) may be configured to increase the threshold (TH) when the moving mechanism (14) is accelerating or decelerating during machining. This configuration makes it possible to suppress occurrence of an erroneous estimation that abnormal vibration is likely to be occurring even though no abnormal vibration has actually occurred.

The estimation unit (28) may be configured to suspend estimation when the moving mechanism (14) is accelerating or decelerating during machining. This configuration makes it possible to suppress occurrence of an erroneous estimation that abnormal vibration is likely to be occurring even though no abnormal vibration has actually occurred.

The machine tool (10) may further include a notification unit (30) configured to, when it is estimated that abnormal vibration is likely to have occurred in the spindle (12a), issue a notification to the effect that it has been estimated that abnormal vibration is likely to have occurred in the spindle (12a). This configuration makes it to prompt the operator to inspect the abnormal vibration.

The motor control unit (24) may be configured to stop the motor (20) when it is estimated that abnormal vibration is likely to have occurred in the spindle (12a). This configuration makes it possible to prevent the workpiece from being machined when it is estimated that abnormal vibration is likely to have occurred.

The motor control unit (24) may be configured to stop the motor (20) at a higher deceleration rate as the degree to which the intensity exceeds the threshold (TH) to deviate from the threshold (TH) is greater. With this configuration, the higher the possibility of occurrence of abnormal vibration becomes, the more quickly the movement of the moving mechanism (14) can be stopped, and it is possible to prevent the workpiece from being machined.

The motor control unit (24) may be configured to increase the deceleration rate at which the motor (20) is stopped, in a stepwise manner according to the degree to which the intensity exceeds the threshold (TH) to deviate from the threshold (TH). With this configuration, the higher the possibility of occurrence of abnormal vibration becomes, the more quickly the movement of the moving mechanism (14) can be stopped, and it is possible to prevent the workpiece from being machined.

The driving state of the motor (20) may be represented by at least one of the positional deviation, the speed deviation, the acceleration deviation, the jerk deviation, the electric current value, the speed, the acceleration, and the jerk, of the motor (20).

### <Fourth Aspect of the Invention>

The fourth aspect of the invention resides in a vibration estimation method for estimating abnormal vibration of a spindle (12a) of a machine tool (10), the machine tool including a spindle unit (12) configured to rotatably support the spindle (12a), a moving mechanism (14) configured to move the spindle unit (12), a motor (20) configured to drive the moving mechanism (14), and a motor control unit (24) configured to control the motor (20). The vibration estimation method includes: an acquisition step (S1) of acquiring a signal indicating the driving state of the motor (20); and an estimation step (S2) of estimating that abnormal vibration is likely to have occurred in the spindle (12a) when the intensity of the frequency component, contained in the signal acquired at the acquisition step (S1), that has the same frequency as the rotation frequency of the spindle (12a), exceeds a predetermined threshold (TH).

This method makes it possible to detect abnormal vibration without providing any vibration sensor, and hence reduce the number of parts of the machine tool (10).

The estimation step (S2) may increase the threshold (TH) when the moving mechanism (14) is accelerating or decelerating during machining. This method makes it possible to suppress occurrence of an erroneous estimation that abnormal vibration is likely to be occurring even though no abnormal vibration has actually occurred.

The estimation step (S2) may suspend estimation when the moving mechanism (14) is accelerating or decelerating during machining. This method makes it possible to suppress occurrence of an erroneous estimation that abnormal vibration is likely to be occurring even though no abnormal vibration has actually occurred.

The vibration estimation method may further include a notifying step (S3) of, when it is estimated that abnormal vibration is likely to have occurred in the spindle (12a), issuing a notification to the effect that abnormal vibration is likely to have occurred in the spindle (12a). This method makes it to prompt the operator to inspect the abnormal vibration.

The vibration estimation method may further include a stopping step (S4) of stopping the motor (20) when it is estimated that abnormal vibration is likely to have occurred in the spindle (12a). This method makes it possible to prevent the workpiece from being machined when it is estimated that abnormal vibration is likely to have occurred.

The stopping step (S4) may stop the motor (20) at a higher deceleration rate as the degree to which the intensity exceeds the threshold (TH) to deviate from the threshold (TH) is greater. With this method, the higher the possibility of occurrence of abnormal vibration becomes, the more quickly the movement of the moving mechanism (14) can be stopped, and it is possible to prevent the workpiece from being machined.

The stopping step (S4) may increase the deceleration rate at which the motor (20) is stopped, in a stepwise manner according to the degree to which the intensity exceeds the threshold (TH) to deviate from the threshold (TH). With this method, the higher the possibility of occurrence of abnormal vibration becomes, the more quickly the movement of the moving mechanism (14) can be stopped, and it is possible to prevent the workpiece from being machined.

The present invention is not particularly limited to the embodiment described above, and various modifications are possible without departing from the essence and gist of the present invention.

What is claimed is:

1. A machine tool comprising:
a spindle unit configured to rotatably support a spindle;
a moving mechanism configured to move the spindle unit;
a motor configured to drive the moving mechanism;
a motor control unit configured to control the motor; and
an estimation unit configured to estimate that abnormal vibration is likely to have occurred in the spindle when an amplitude of a signal indicating a driving state of the motor falls out of a predetermined allowable range.

2. The machine tool according to claim 1, wherein the estimation unit is configured to expand the allowable range when the moving mechanism is accelerating or decelerating during machining.

3. The machine tool according to claim 1, wherein the estimation unit is configured to suspend estimation when the moving mechanism is accelerating or decelerating during machining.

4. The machine tool according to claim 1, further comprising a notification unit configured to, when it is estimated that abnormal vibration is likely to have occurred in the spindle, issue a notification that it has been estimated that abnormal vibration is likely to have occurred in the spindle.

5. The machine tool according to claim 1, wherein the motor control unit is configured to stop the motor when it is estimated that abnormal vibration is likely to have occurred in the spindle.

6. The machine tool according to claim 5, wherein the motor control unit is configured to stop the motor at a higher deceleration rate as a degree to which the amplitude falls out of the allowable range to deviate from the allowable range is greater.

7. The machine tool according to claim 5, wherein the motor control unit is configured to increase a deceleration rate at which the motor is stopped, in a stepwise manner according to a degree to which the amplitude falls out of the allowable range to deviate from the allowable range.

8. The machine tool according to claim 1, wherein the driving state of the motor is represented by at least one of a positional deviation, a speed deviation, an acceleration deviation, a jerk deviation, an electric current value, a speed, an acceleration, and a jerk, of the motor.

9. A vibration estimation method for estimating abnormal vibration of a spindle of a machine tool, the machine tool including a spindle unit configured to rotatably support the spindle, a moving mechanism configured to move the spindle unit, a motor configured to drive the moving mechanism, and a motor control unit configured to control the motor, the vibration estimation method comprising:
an acquisition step of acquiring a signal indicating a driving state of the motor; and
an estimation step of estimating that abnormal vibration is likely to have occurred in the spindle when an amplitude of the signal acquired at the acquisition step falls out of a predetermined allowable range.

10. The vibration estimation method according to claim 9, wherein the estimation step expands the allowable range when the moving mechanism is accelerating or decelerating during machining.

11. The vibration estimation method according to claim 9, wherein the estimation step suspends estimation when the moving mechanism is accelerating or decelerating during machining.

12. The vibration estimation method according to claim 9, further comprising a notifying step of, when it is estimated that abnormal vibration is likely to have occurred in the spindle, issuing a notification that it has been estimated that abnormal vibration is likely to have occurred in the spindle.

13. The vibration estimation method according to claim 9, further comprising a stopping step of stopping the motor when it is estimated that abnormal vibration is likely to have occurred in the spindle.

14. The vibration estimation method according to claim 13, wherein the stopping step stops the motor at a higher deceleration rate as a degree to which the amplitude falls out of the allowable range to deviate from the allowable range is greater.

15. The vibration estimation method according to claim 13, wherein the stopping step increases a deceleration rate at which the motor is stopped, in a stepwise manner according to a degree to which the amplitude falls out of the allowable range to deviate from the allowable range.

16. A machine tool comprising:
a spindle unit configured to rotatably support a spindle;
a moving mechanism configured to move the spindle unit;
a motor configured to drive the moving mechanism;
a motor control unit configured to control the motor; and
an estimation unit configured to estimate that abnormal vibration is likely to have occurred in the spindle when an intensity of a frequency component, contained in a signal indicating a driving state of the motor, that has a frequency identical to a rotation frequency of the spindle, exceeds a predetermined threshold.

17. The machine tool according to claim 16, wherein the estimation unit is configured to increase the threshold when the moving mechanism is accelerating or decelerating during machining.

18. The machine tool according to claim 16, wherein the estimation unit is configured to suspend estimation when the moving mechanism is accelerating or decelerating during machining.

19. The machine tool according to claim 16, further comprising a notification unit configured to, when it is estimated that abnormal vibration is likely to have occurred in the spindle, issue a notification that it has been estimated that abnormal vibration is likely to have occurred in the spindle.

20. The machine tool according to claim 16, wherein the motor control unit is configured to stop the motor when it is estimated that abnormal vibration is likely to have occurred in the spindle.

21. The machine tool according to claim 20, wherein the motor control unit is configured to stop the motor at a higher deceleration rate as a degree to which the intensity exceeds the threshold to deviate from the threshold is greater.

22. The machine tool according to claim 20, wherein the motor control unit is configured to increase a deceleration rate at which the motor is stopped, in a stepwise manner according to a degree to which the intensity exceeds the threshold to deviate from the threshold.

23. The machine tool according to claim 16, wherein the driving state of the motor is represented by at least one of a positional deviation, a speed deviation, an acceleration deviation, a jerk deviation, an electric current value, a speed, an acceleration, and a jerk, of the motor.

24. A vibration estimation method for estimating abnormal vibration of a spindle of a machine tool, the machine tool including a spindle unit configured to rotatably support the spindle, a moving mechanism configured to move the spindle unit, a motor configured to drive the moving mechanism, and a motor control unit configured to control the motor, the vibration estimation method comprising:
an acquisition step of acquiring a signal indicating a driving state of the motor; and
an estimation step of estimating that abnormal vibration is likely to have occurred in the spindle when an intensity of a frequency component, contained in the signal acquired at the acquisition step, that has a frequency identical to a rotation frequency of the spindle, exceeds a predetermined threshold.

25. The vibration estimation method according to claim 24, wherein the estimation step increases the threshold when the moving mechanism is accelerating or decelerating during machining.

26. The vibration estimation method according to claim 24, wherein the estimation step suspends estimation when the moving mechanism is accelerating or decelerating during machining.

27. The vibration estimation method according to claim 24, further comprising a notifying step of, when it is estimated that abnormal vibration is likely to have occurred in the spindle, issuing a notification that it has been estimated that abnormal vibration is likely to have occurred in the spindle.

28. The vibration estimation method according to claim 24, further comprising a stopping step of stopping the motor when it is estimated that abnormal vibration is likely to have occurred in the spindle.

29. The vibration estimation method according to claim 28, wherein the stopping step stops the motor at a higher deceleration rate as a degree to which the intensity exceeds the threshold to deviate from the threshold is greater.

30. The vibration estimation method according to claim 28, wherein the stopping step increases a deceleration rate at which the motor is stopped, in a stepwise manner according to a degree to which the intensity exceeds the threshold to deviate from the threshold.
